(19) United States
(12) Patent Application Publication
(10) Pub. No.: US 2026/0361330 A1
(43) Pub. Date: Nov. 12, 2026

(54) Sensor and Computing Device Dual-Mounting Bracket with Attachment Options

(71) Applicant: TAG Sports and Outdoor, LLC, Lawrence, KS (US)

(72) Inventors: Yilun Su, Beijing (CN); Jiachao Tang, Beijing (CN); Logan Tuel, Kansas City, MO (US); Luke Hornberger, Lawrence, KS (US); Zongbo Wang, Lawrence, KS (US); Jarrod Nichols, Olathe, KS (US)

(21) Appl. No.: 19/200,361

(22) Filed: May 6, 2025

(51) Int. Cl. H04B 1/3888; H04M 1/04

(52) U.S. Cl. CPC H04B 1/3888; H04M 1/04; H04M 2201/08

(57) ABSTRACT

A dual-sided mounting bracket apparatus is disclosed for simultaneously securing a sensor device with a magnetic mount capability and a computing device. The apparatus includes a central body with a first surface having a magnetic ring interface for removably attaching a radar or sensor device with a magnetic mount capability, and a second surface with a clamp arm assembly configured to retain a computing device of variable size. The central body further includes a mounting hole attachment mechanism for coupling to a support structure, and may include one or more apertures for receiving straps or other securing elements. The configuration enables convenient alignment and simultaneous operation of both devices in portable or field-based environments, such as athletic training or motion tracking applications.

### TECHNICAL FIELD

This disclosure relates generally to mechanical accessories for electronic devices and, more specifically, to dual-sided mounting bracket systems configured to support the simultaneous attachment of a sensor device having a magnetic mount capability and a computing device to a shared support structure.

### BACKGROUND

Portable sensors and computing devices (such as smartphones, tablets, or data loggers) often need to be used together for data collection or monitoring. Tripods or stationary mounts are commonly used to support individual devices like cameras or sensors for stability. Conventional device mounts, however, typically hold only one device at a time and offer limited mounting options. For instance, a user may mount a camera or sensor on a tripod using a standard screw mount, while a separate handheld computing device remains unsupported or requires an additional holder. In other cases, users resort to ad-hoc solutions (e.g., tape or zip ties) to attach devices to poles or trees when a tripod is impractical. These approaches can be cumbersome and cause misalignment of the devices or risk equipment falling or shifting.

### SUMMARY

The systems, methods and devices of this disclosure each have several innovative aspects, no single one of which is solely responsible for the desirable attributes disclosed herein.

One aspect of the disclosed subject matter relates to a dual-sided mounting bracket apparatus for securing both a sensor device having a magnetic mount capability and a computing device. The apparatus includes a central body having a first surface and a second surface on opposite sides. The first surface comprises a magnetic ring interface configured to removably secure a radar device or other sensor with a compatible magnetic interface. On the second surface, the bracket includes a clamp arm assembly configured to retain a computing device of variable size. The clamp assembly includes at least one extendable arm that extends laterally from opposing sides of the central body to accommodate different form factors. The bracket further includes a mounting hole attachment mechanism at one end of the central body, such as a threaded insert for tripod attachment. Additionally, one or more apertures extend through the central body and are sized and positioned to receive a strap, Velcro loop, or other securing element for alternative mounting scenarios, such as to a fence or pole.

Another aspect of the disclosed subject matter provides a dual-sided mounting bracket apparatus that includes a central body having a first surface and a second surface opposite the first surface. A magnetic ring interface is disposed on the first surface and is configured to removably secure a radar device having a compatible magnetic interface. A clamp arm assembly is positioned on the second surface and includes at least one extendable arm that is configured to laterally extend from opposing sides of the central body to retain a computing device of variable size. A mounting hole attachment mechanism is positioned at one end of the central body, enabling the bracket to be mechanically secured to an external support structure via a threaded fastener or similar component.

A further aspect of the subject matter described in this disclosure is directed to a dual-sided mounting bracket apparatus that includes a central body with a first surface and a second surface opposite the first surface. The first surface includes a magnetic ring interface configured to removably secure a radar device having a compatible magnetic interface. The second surface includes a clamp arm assembly having at least one extendable arm, the arm being configured to extend laterally from opposing sides of the central body to retain a computing device of variable size. The central body further includes at least one aperture extending through its structure. The aperture is sized and positioned to receive a strap or similar securing element for mounting the bracket to an external structure.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a perspective view of a dual-sided mounting bracket apparatus showing a central body with a first surface for receiving a sensor device having a magnet mount capability and a second surface for receiving a computing device.

FIG. 2 is a perspective view of the bracket apparatus shown in FIG. 1, taken from the opposite angle, illustrating an opposite side of the central body and clamp arm assembly.

FIG. 3 is an elevation view of the bracket apparatus illustrating the second surface of the central body, the clamp arms in a retracted state, and the overall lateral arrangement of the assembly.

FIG. 4 is an elevation view of the bracket apparatus from the side opposite that shown in FIG. 3, illustrating the first surface of the central body and the mounting interface for a sensor device with a magnetic mount capability.

FIG. 5 is a side elevation view of the bracket apparatus illustrating the profile of the clamp arm assembly and the central body, including the relative thickness of structural components.

FIG. 6 is a side elevation view of the bracket apparatus taken from the opposite side of FIG. 5, further illustrating the clamp arm assembly and the depth configuration of the central body.

FIG. 7 is a top-plan view of the bracket apparatus illustrating the positioning and curvature of the clamp arms relative to the central body.

FIG. 8 is a bottom plan view of the bracket apparatus illustrating the configuration of the mounting hole and apertures for strap-based attachment.

### DETAILED DESCRIPTION

The following detailed description is merely exemplary in nature and is not intended to limit the invention or the application and uses of the invention. The terminology used herein is for clarity and illustrative purposes only and is not intended to be limiting.

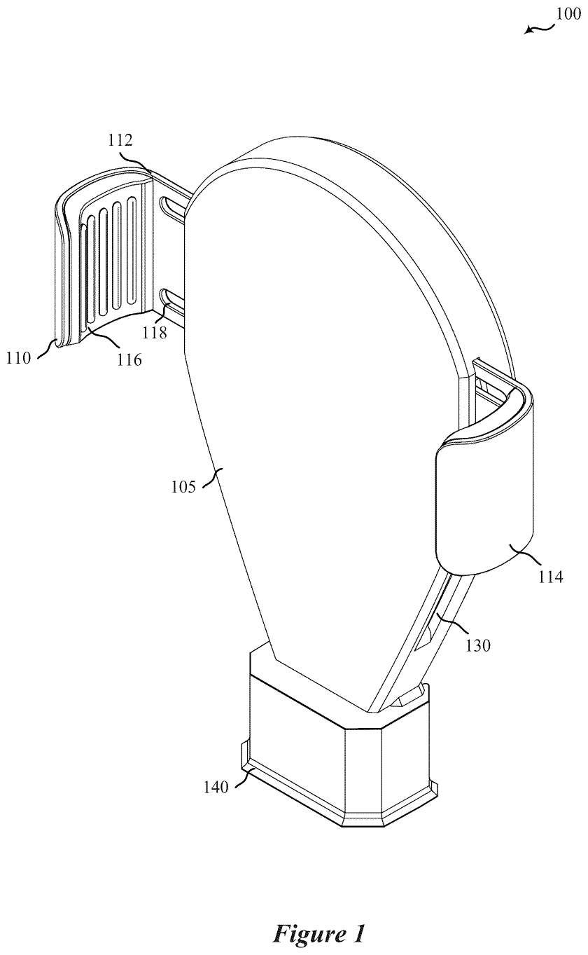

FIG. 1 illustrates an example embodiment of a dual-sided mounting bracket apparatus 100 configured to simultaneously secure a device, such as a radar unit, and a computing device, such as a smartphone or tablet, to a shared central structure. The design can facilitate integrated data capture and analysis during sports training or field-based performance monitoring.

The dual-sided mounting bracket apparatus 100 includes a central body 105 having a first surface and a second surface on opposing sides. A magnetic ring interface (not shown) is positioned on the first surface of the central body 105 and is configured to magnetically couple with a compatible device. On the second surface of the central body, a clamp arm assembly 110 is mounted, which includes a pair of laterally extendable arms (112, 114) designed to securely retain a computing device of variable width. These arms are supported and guided by structural channels 118 integrated into the body and may be spring-biased for a secure grip. The lower end of the central body includes a mounting hole attachment mechanism 140, such as a threaded ¼-20 insert, enabling the dual-sided mounting bracket apparatus 100 to be secured to a standard tripod or other support structures. Additionally, one or more apertures 130 extend through the central body, providing passageways for straps or Velcro loops to facilitate alternative mounting to fences, poles, or similar external structures. All components are mechanically interconnected through molded joints or fasteners within the central body, creating a rigid and integrated system for dual-device support for a sensor and computing device.

The central body 105 of the dual-sided mounting bracket apparatus (100) can be a rigid, monolithic structural component to which the other functional elements are coupled. The central body 105 can include opposing first and second surfaces configured respectively for the attachment of a radar device with a magnetic mount capability and a computing device. The geometry of the central body is contoured in a generally tapered or wedge-like profile, with a broader upper portion for mechanical stability and a narrower lower section designed to interface with a mounting mechanism.

The second surface of the central body 105 supports the clamp arm assembly 110, which is mechanically integrated into lateral channels or guide slots embedded in the sidewalls of the central body 105. These channels guide the opposing clamp arms as they extend and retract to accommodate computing devices of various widths. The clamp arms 112, 114 may be biased inward using integrated spring elements housed within the lateral walls of the body. Optional texturing or soft contact pads may be included at the clamp interface to improve grip and reduce slippage during operation.

Integrated within the central body 105 are one or more through-apertures 130 extending transversely across the body. The apertures 130 are dimensioned and spaced to permit the passage of straps, Velcro loops, or similar securing elements, enabling the apparatus to be mounted to alternative support structures such as chain link fences, poles, or netting when a tripod is not feasible.

At the lower end of the central body, a mounting hole attachment mechanism 140 is formed, which can include a threaded insert for compatibility with standard tripod mounting screws. The region surrounding the insert is optionally flanged or recessed to enhance mechanical fit and stability. The underside of the central body may further incorporate notches or pass-through slots to facilitate cable routing, allowing charging cables to run from the computing device or radar unit without obstruction during use.

The central body 105 may be formed from an impact-resistant polymer or lightweight alloy and optionally overmolded with elastomeric materials at key contact points to improve grip, durability, and environmental resistance. In some examples, the entire structure is sealed to meet IP67 water and dust ingress standards, allowing reliable operation in outdoor and field environments, including light rain and dust exposure.

The clamp arm assembly 110 is mounted to the second surface of the central body 105 and is designed to retain a portable computing device, such as a smartphone, by applying adjustable lateral pressure. The assembly can include a pair of opposing extendable arms 112, 114, which are positioned on opposite lateral sides of the central body 105. The arms 112, 114 are configured to extend outwardly to accommodate the width of the computing device and then return inward to securely grip it.

Each extendable arm 112, 114 is seated within a corresponding structural channel 118 formed along the lateral edge of the central body. These channels act as precision-guided tracks, allowing each arm to slide linearly along a single axis. The channel walls are molded or machined with smooth internal surfaces or retention ribs that maintain the alignment of the arms and limit unwanted flex or drift during motion. The arms 112, 114 are capable of moving independently or together, depending on the required grip width, and are retained within the channels in a manner that prevents dislocation during field use.

To ensure firm and stable contact with the computing device, the interior-facing sides of the arms are equipped with inward-facing padding 116. This padding can be formed from a compliant, high-friction material such as silicone, rubber, or elastomeric foam and is designed to cushion the device during insertion and resist slippage once in place. The padding material may have a textured surface to further increase friction and stability, especially during dynamic use cases like sports training or outdoor deployment.

A spring-loaded mechanism (not shown) can be integrated within the structural housing of the central body 105 and arms 112, 114, applying constant inward force that causes the arms to naturally return to a closed, gripping position when not actively spread apart. This internal bias ensures that the computing device remains securely held in the bracket, even when subjected to movement or vibration. The combination of lateral adjustability, spring tension, and padded contact surfaces enables the assembly to accommodate a wide range of device widths while providing a firm, centered, and aligned hold during operation.

The clamp arm assembly 110 is anchored securely to the central body and integrated into its structural design, allowing it to maintain rigidity and alignment under varying load conditions. The overall configuration enables fast, tool-free attachment and removal of a computing device in both stationary and portable setups and ensures continued alignment with the sensor device magnetically mounted on the opposing side of the bracket.

The aperture slots 130 are integrated structural features formed through the central body 105 of the mounting bracket apparatus. These slots are designed to enable alternative mounting configurations, particularly when the dual-sided mounting bracket apparatus 100 is used in environments where traditional tripod attachment is impractical or unavailable. Each aperture extends transversely through the thickness of the central body, from one side to the other, and is dimensioned to receive flexible securing elements such as straps, Velcro ties, zip cords, or fabric loops.

The positioning of the aperture slots 130 can be located near the base of the central body 105, adjacent to or surrounding the mounting hole attachment mechanism, in a region that allows for balanced load distribution when the dual-sided mounting bracket apparatus 100 is mounted vertically or suspended. The geometry of each aperture may be elongated, oblong, or rectangular, ensuring compatibility with a variety of strap widths and thicknesses. The internal edges of the slots can be smoothly contoured or chamfered to prevent wear or fraying of soft strap materials during prolonged use.

Internally, the slots can pass through reinforced segments of the body 105 to maintain structural rigidity and avoid compromising the bracket's strength. These reinforced segments may be molded or integrally cast as part of the main body during fabrication. The design accommodates high-tension forces without deformation, ensuring that the bracket remains securely fastened when strapped to objects such as fences, poles, dugout railings, or net posts commonly found in athletic environments.

In some examples, the outer surface surrounding each aperture 130 may feature a recessed groove or a molded strap channel to help align the strap and prevent lateral slippage once secured. This ensures the bracket maintains a stable orientation during use, preserving sensor alignment and minimizing the risk of unintentional rotation or tilt.

The mounting hole attachment mechanism 140 is positioned at the lower end of the central body 105 and can serve as the primary structural interface for securing the dual-sided mounting bracket apparatus 100 to an external support structure, such as a tripod, monopod, mounting plate, or stand. The mounting hole attachment mechanism 140 can be designed to ensure a secure and stable mechanical coupling while maintaining compatibility with widely used industry standards.

In some examples, the mounting hole attachment mechanism 140 includes a threaded insert embedded within the central body, such as a ¼-20 UNC thread specification. This threaded insert is dimensioned to receive a standard ¼-inch diameter screw with 20 threads per inch—commonly used in photographic and videographic equipment. The insert can be anchored within a reinforced base portion of the central body and can be constructed from a durable metallic material, such as brass or stainless steel, to resist wear, corrosion, and stripping under repeated use.

In some examples, the surrounding area of the mounting hole attachment mechanism 140 is recessed or countersunk to allow the head of the tripod screw or adapter to sit flush or semi-flush with the surface of the bracket, ensuring a tight and flush mounting interface. The external shape of this lower region may include flat surfaces, flanges, or molded ridges to provide additional grip and prevent rotational slippage when the bracket is mounted and adjusted.

The structure around the mounting hole can be reinforced to withstand the torque and mechanical load typically applied during tripod mounting. This reinforcement may include a thickened base wall, internal ribbing, or material densification during molding to ensure long-term structural integrity even under field conditions involving vibration or movement.

Additionally, the layout of the mounting hole in relation to the rest of the central body is designed to preserve the vertical alignment of the mounted sensor and computing devices. When attached to a tripod or monopod via the mounting hole, the bracket maintains a balanced and upright orientation, allowing the sensor (on the first surface) to maintain a direct line-of-sight to a target area, while the computing device (on the second surface) remains viewable and accessible.

In some examples, the area surrounding the mounting hole may also include small slots or cutouts to facilitate cable routing, allowing charging or data cables to pass unobstructed while the bracket is in use. This allows both the radar device and computing device to remain connected to power sources or data systems without interference from the mounting hardware.

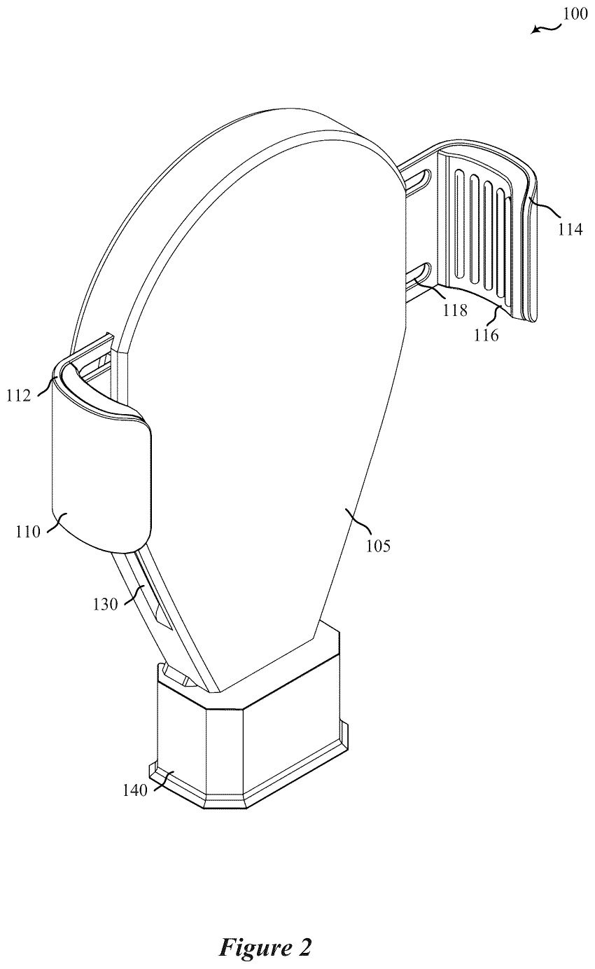

FIG. 2 illustrates an example of a rotated perspective view of the dual-sided mounting bracket apparatus 100, which provides enhanced visual access to the configuration and features of the clamp arm assembly, structural guide channels, and inward-facing grip surfaces. This view complements the orientation shown in FIG. 1 by exposing previously obscured internal elements and emphasizing the geometric relationships between components.

As shown, the extendable arms 112, 114 of the clamp arm assembly (110) are attached on the second side of the body 105. These arms are laterally extended outward from the central body 105 and are configured to slide within structural guide channels 118 formed into the lateral walls of the body. The guide channels 118 are shown with open slots that constrain the arms to linear, opposing motion along the lateral axis of the bracket. These channels support the structural integrity of the clamp mechanism and ensure proper alignment during operation.

As also shown is the inward-facing padding 116 affixed to the interior surfaces of arms 112 and 114. The padding includes vertically oriented ridges or grip surfaces that provide frictional resistance and cushioning between the clamped computing device and the bracket arms. These surfaces improve retention and reduce the risk of slippage, particularly during motion or vibration.

The aperture slot 130 is visible along the mid-lower portion of the central body 105, positioned to accommodate securing straps or loops. This slot passes through the central body and is dimensioned to accept flexible elements such as Velcro or corded straps, allowing the entire bracket assembly to be mounted onto fences, poles, or other structures when a tripod is not used.

At the base of the assembly, the mounting hole attachment mechanism 140 is again shown, here with additional visibility into its flanged base design. The square flange around the threaded insert adds stability and rotational resistance when the bracket is mounted to a tripod or similar hardware.

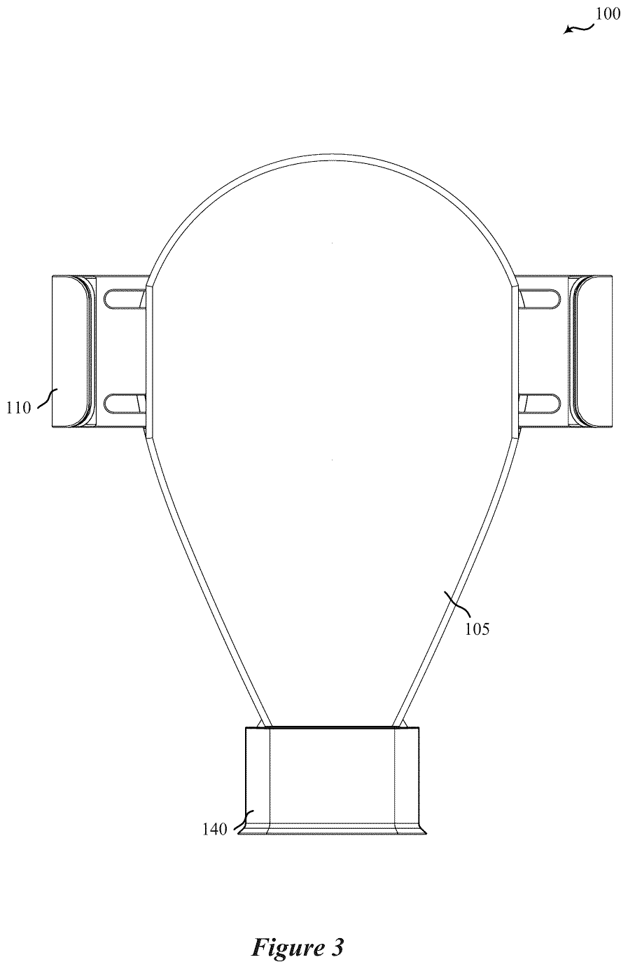

FIG. 3 illustrates an example frontal elevation view of the dual-sided mounting bracket apparatus 100, as seen directly from the side of the second surface configured to support and retain a computing device via the clamp arm assembly 110. This orthogonal perspective emphasizes the overall lateral symmetry and geometric structure of the assembly, including the layout and proportions of the central body 105, clamp components, and mounting features.

The central body 105 appears in its vertically tapered configuration, which is broad at the top where it interfaces with the clamp arm assembly and narrows toward the base where the mounting hardware resides. The contour of the central body in this view highlights its balanced, symmetrical shape, which promotes stability during use and uniform load distribution when mounted.

Flanking either side of the upper portion of the central body are the two extendable clamp arms 112, 114, which are shown in an extended state. The arms extend laterally outward and are supported by underlying structural guide features embedded in the central body (not visible in this figure, but as shown in FIGS. 1 and 2). From this view, the arms appear to project symmetrically from the left and right sides, forming the adjustable mechanism used to hold computing devices of varying widths.

The mounting hole attachment mechanism 140 is shown centered at the base of the central body. The symmetry and centering of the mounting mechanism can ensure that when attached to a support structure, the bracket remains upright and balanced during use.

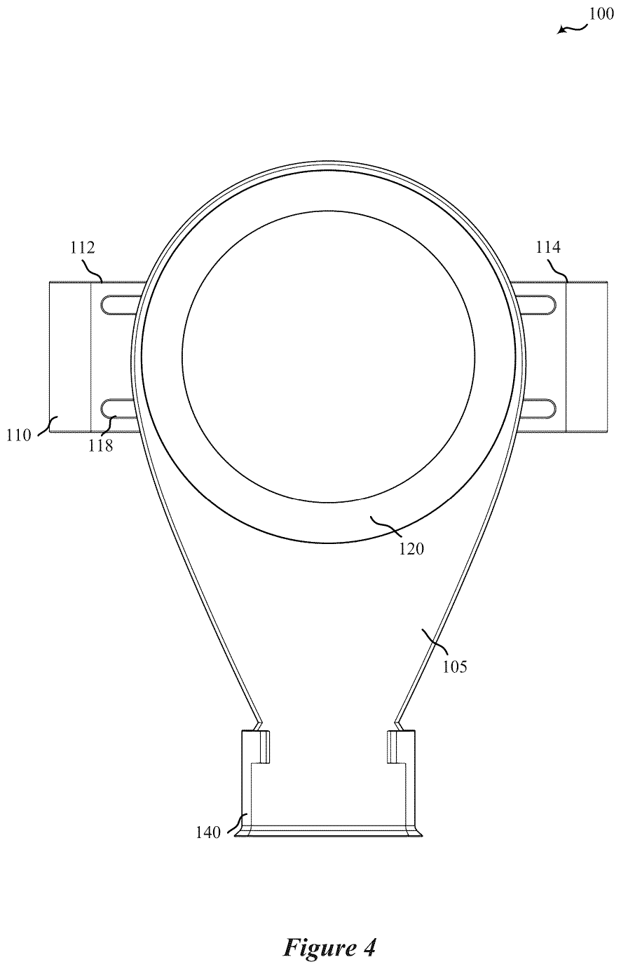

FIG. 4 illustrates an example rear elevation view of the first surface of the dual-sided mounting bracket apparatus 100, including the mounting configuration intended for a sensor device with a magnetic mount capability. This view reveals the structural orientation of the magnetic interface as well as the spatial arrangement of adjacent components.

The central body 105 is shown in its vertically elongated form, with a wider upper region that tapers downward toward the base, where the mounting hole attachment mechanism 140 is centered. This view is symmetrical about the vertical axis and is oriented so that the first surface is fully visible.

As shown, the magnetic ring interface 120 is centered on the first surface. The magnetic ring interface 120 can include a circular or elliptical recessed region located at the upper portion of the first surface. Within this region, a ring-shaped magnetic structure is embedded or secured to the body, forming a closed loop that defines the attachment zone for a compatible device, such as a radar device. The ring may be composed of a series of evenly spaced permanent magnets or a continuous magnetic material, such as a ferrite or neodymium alloy, enclosed within a polymeric or elastomeric housing. This construction ensures uniform magnetic force distribution across the entire circumference of the interface.

The outer profile of the magnetic ring can be shaped to correspond to the rear housing geometry of the compatible device, which includes a complementary magnetic surface. When brought into proximity, the device is drawn into secure alignment with the ring interface by magnetic attraction, maintaining a centered and planar contact orientation. This configuration ensures the device remains aligned for optimal directional accuracy and data collection while resisting lateral or rotational displacement during use.

In some examples, the magnetic ring interface 120 may include shallow alignment ridges, recessed guide channels, or detent features integrated within the surface surrounding the magnetic array. These passive locating structures can help to orient the device in a fixed angular position relative to the central body 105, minimizing setup time and eliminating user guesswork during repeated deployments.

In some examples, the magnetic ring can be mechanically reinforced within the body 105 by means of a molded carrier pocket or structural cavity, which secures the magnet array in place and isolates it from mechanical shock or vibration. In some examples, the magnetic ring is encased in a non-conductive, weather-resistant overmold, protecting it from environmental factors such as moisture, dust, and temperature fluctuations.

The axial alignment of the magnetic ring interface 120 with the mounting hole attachment mechanism 140 at the base of the central body 105 can ensure that the device, when mounted, is vertically aligned with the tripod or strap-mounted axis.

Flanking the central magnetic interface 120 are the clamp arm components 112, 114, part of the opposing surface's clamp arm assembly. Although these arms primarily function on the second surface, their structural extensions are visible here due to the depth of their mounting tracks within the body. Small cutouts and passageways in the side of the central body reveal segments of the guide channels 118 that house the clamp arms.

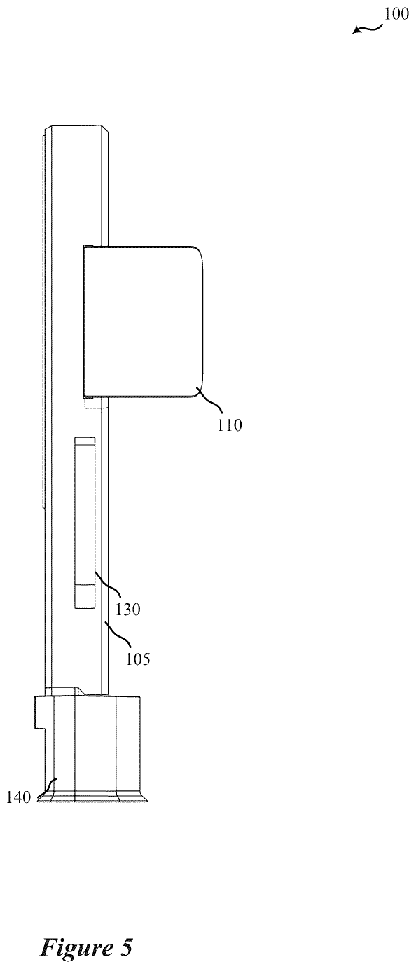

FIG. 5 illustrates an example side profile view of the mounting bracket apparatus 100, oriented such that the clamp arm assembly 110 is prominently visible in the foreground. This view provides a clear understanding of the depth profile of the device and its vertical stacking structure, showing how components are layered relative to one another along the lateral axis.

The central body 105 forms the structural spine of the bracket, extending vertically from the mounting hole attachment mechanism 140 at the base to the upper region where the magnetic interface resides (not visible from this angle). The body's sidewall is shown as a continuous vertical surface, slightly tapering toward the lower end to optimize weight distribution and streamline the overall shape.

Attached to the side of the body 105 is the clamp arm assembly 110, seen in its retracted or neutral position. The clamp arm projects outward from the side surface, with its depth dimension designed to accommodate typical smartphone or computing device thicknesses. The arm maintains a squared-off profile for secure engagement with a mounted device.

Along the central region of the body, the aperture slot 130 is visible in the side elevation illustration. This slot is recessed through the thickness of the body and runs perpendicular to the viewing plane. It is dimensioned to accept a strap or securing loop and is positioned to enable balanced mounting to external surfaces such as fences or poles.

At the bottom, the mounting hole attachment mechanism 140 is shown in its cylindrical housing. The geometry of the base appears flanged to increase surface area and improve mounting stability when affixed to a tripod or threaded base.

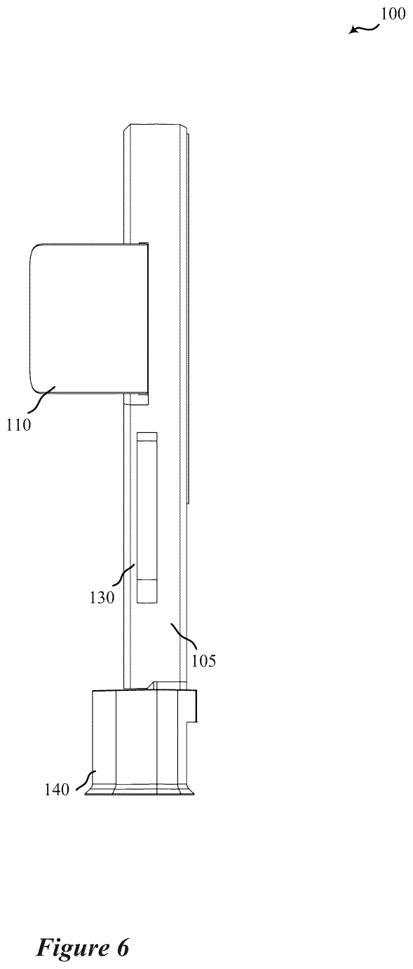

FIG. 6 illustrates an example opposite side profile of the same mounting bracket apparatus 100, providing a mirrored perspective relative to FIG. 5. The clamp arm assembly 110 is again visible, though this time viewed from the reverse angle. The shape and depth of the clamp arm confirm its symmetrical extension capability, designed to operate laterally across both sides of the body.

As in FIG. 5, the aperture slot 130 appears recessed into the sidewall of the central body. This view further emphasizes the alignment of the slot with the vertical axis of the bracket and highlights how the slot is cleanly formed into the body without compromising structural integrity.

The mounting hole attachment mechanism 140 is again shown at the bottom. From this angle, the concentric base of the mount appears centered relative to the vertical taper of the body, confirming that the bracket is designed to maintain upright alignment when affixed to a support structure.

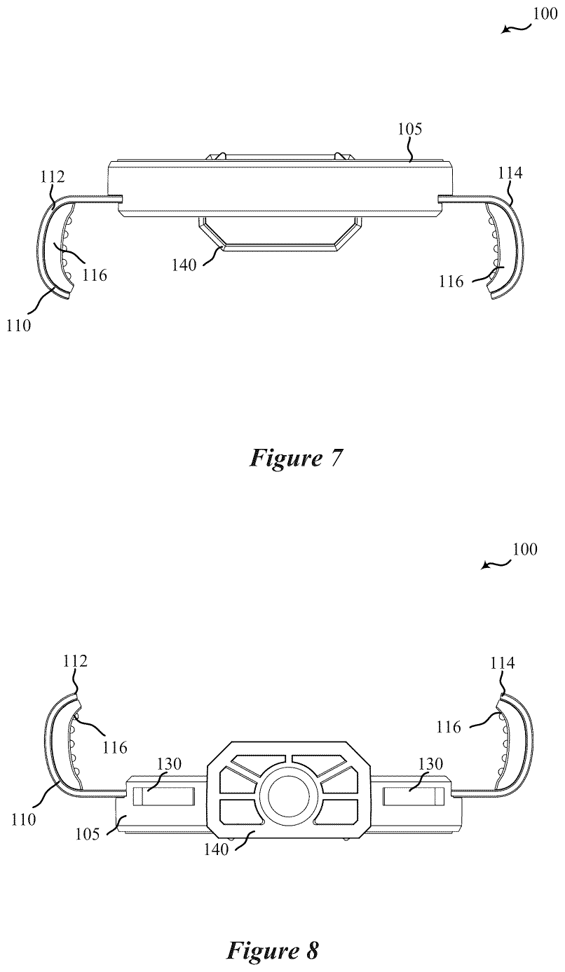

FIG. 7 illustrates an example top plan view of the mounting bracket apparatus 100, showing the structural arrangement and lateral extension of the clamp arm assembly on the second surface of the central body 105.

The central body 105 is shown in its horizontal cross-section, appearing as a relatively thin structure in this orientation, with a broad central plane from which other components extend. At each side of the body, a pair of opposing clamp arms 112, 114 are shown extended outward.

The distal ends of clamp arms 112 and 114 terminate in curved contact surfaces 116, which are configured to engage and retain the sides of a computing device such as a smartphone or tablet. These curved surfaces include a textured or padded interface to improve friction and minimize slippage. The arc-shaped inner edges of the padding 116 allow the clamp arms to grip devices securely, while distributing pressure across a wider area.

FIG. 8 illustrates an example bottom plan view of the same apparatus 100, offering a detailed view of the mounting and strap-attachment features, along with the internal mechanism alignment of the clamp arms.

At the center of the base of the central body 105 is the mounting hole attachment mechanism 140. The mechanism 140 features a centrally located threaded insert surrounded by a reinforced hexagonal or multi-ribbed housing, which improves structural durability and distributes mechanical load when the bracket is mounted to a tripod or other standard threaded fixture.

On either side of the mounting hole, a pair of transverse aperture slots 130 is visible. These slots extend through the width of the central body and are dimensioned to receive flexible fastening elements such as Velcro straps or cords. Their placement provides an alternative to tripod mounting, enabling secure attachment to poles, fences, or netting.

The clamp arms 112, 114 are again visible from this underside view, extending outward from the sidewalls of the central body. The curved interior gripping surfaces 116 are prominently displayed, confirming the semi-circular profile and padded design of the contact interfaces.

While the invention has been described in terms of specific embodiments, it should be understood that various changes, substitutions, and modifications may be made without departing from the spirit or scope of the invention. The embodiments described are illustrative and not restrictive, and the scope of the invention should be determined by the claims that follow.

What is claimed is:

1. A dual-sided mounting bracket apparatus for securing a sensor device with a magnetic mount capability and a computing device, the apparatus comprising:
a central body having a first surface and a second surface opposite to the first surface;
a magnetic ring interface on the first surface, the magnetic ring interface configured to removably secure a radar device having a compatible magnetic interface,
a clamp arm assembly positioned on the second surface, the clamp arm assembly including at least one extendable arm configured to laterally extend from opposing sides of the central body to retain a computing device of variable size;
a mounting hole attachment mechanism at one end of the central body; and
at least one aperture extending through the central body, the aperture being sized and positioned to receive a strap for securing the bracket to a separate support structure.

2. The apparatus of claim 1, wherein the clamp arm assembly comprises a pair of opposing arms extendable from lateral sides of the central body.

3. The apparatus of claim 2, wherein the opposing arms are biased inwardly by a spring mechanism to securely grip a computing device.

4. The apparatus of claim 1, wherein the clamp arm assembly includes inward-facing padding or textured surfaces to enhance grip and reduce slippage.

5. The apparatus of claim 1, wherein the clamp arm assembly is configured to accommodate computing devices.

6. The apparatus of claim 1, further comprising a rotatable joint coupled to the mounting hole attachment mechanism, allowing the central body to be angled or oriented during use.

7. The apparatus of claim 1, wherein the mounting hole attachment mechanism comprises a threaded ¼-20 insert for compatibility with a standard tripod.

8. The apparatus of claim 1, further comprising one or more apertures configured to receive a strap, Velcro tie, or similar fastener for securing the bracket to a fence, pole, or other structure.

9. The apparatus of claim 1, wherein the magnetic ring interface and the clamp arm assembly are arranged such that the radar device and the computing device are mounted in opposing directions.

10. The apparatus of claim 1, wherein the central body is made from an impact-resistant polymer with sealing features.

11. The apparatus of claim 1, further comprising cable routing features integrated into the central body to allow charging cables to pass through during use.

12. The apparatus of claim 1, wherein the central body is shaped to maintain line-of-sight between the radar device and a moving object when the computing device is mounted.

13. The apparatus of claim 1, wherein the clamp arm assembly is modular, allowing for replacement with alternate mounting configurations.

14. The apparatus of claim 1, wherein the clamp arm assembly is configured to enable a replacement with alternative mounting elements.

15. The apparatus of claim 1, wherein the central body includes alignment tracks to guide the clamp arm assembly.

16. The apparatus of claim 1, wherein the central body includes an aperture sized for routing a cable between the radar device and the computing device.

17. The apparatus of claim 1, further comprising a strap retainer molded into the body to prevent displacement of the strap during lateral motion.

18. The apparatus of claim 1, wherein the central body is shaped to maintain radar line-of-sight.

19. A dual-sided mounting bracket apparatus for securing a sensor device with a magnetic mount capability and a computing device, the apparatus comprising:
a central body having a first surface and a second surface opposite to the first surface;
a magnetic ring interface on the first surface, the magnetic ring interface configured to removably secure a radar device having a compatible magnetic interface,
a clamp arm assembly positioned on the second surface, the clamp arm assembly including at least one extendable arm configured to laterally extend from opposing sides of the central body to retain a computing device of variable size; and
a mounting hole attachment mechanism at one end of the central body.

20. A dual-sided mounting bracket apparatus for securing a sensor device with a magnetic mount capability and a computing device, the apparatus comprising:
a central body having a first surface and a second surface opposite to the first surface;
a magnetic ring interface on the first surface, the magnetic ring interface configured to removably secure a radar device having a compatible magnetic interface;
a clamp arm assembly positioned on the second surface, the clamp arm assembly including at least one extendable arm configured to laterally extend from opposing sides of the central body to retain a computing device of variable size; and
at least one aperture extending through the central body, the aperture being sized and positioned to receive a strap for securing the bracket to a separate support structure.
